(19) United States
(12) Patent Application Publication
(10) Pub. No.: US 2025/0389844 A1
(43) Pub. Date: Dec. 25, 2025

(54) ZONE CONTROL UNIT PROCESSING RADAR SIGNAL, OPERATING METHOD OF THE SAME, AND VEHICLE INCLUDING ZONE CONTROL UNIT

(71) Applicant: Samsung Electronics Co., Ltd., Suwon-si (KR)

(72) Inventor: SEUNGCHEOL LEE, Suwon-si (KR)

(21) Appl. No.: 19/248,842

(22) Filed: Jun. 25, 2025

(30) Foreign Application Priority Data
Jun. 25, 2024 (KR) 10-2024-0083095

(51) Int. Cl. G01S 13/89; G01S 13/02

(52) U.S. Cl. CPC G01S 13/89; G01S 13/02

(57) ABSTRACT

A system-on-chip according to an embodiment of the present disclosure includes a first processor and a second processor that controls the first processor and controls transmission/reception data through a first network link and a second network link, and the first processor processes radar raw data to generate point cloud data, and the first network link receives the radar raw data from a radar sensor based on a first communication method under control of the second processor, and the second network link transmits the point cloud data to an external processor based on a second communication method different from the first communication method under control of the second processor.

### CROSS-REFERENCE TO RELATED APPLICATIONS

This application claims priority under 35 U.S.C. § 119 to Korean Patent Application No. 10-2024-0083095 filed on Jun. 25, 2024, in the Korean Intellectual Property Office, the disclosure of which is incorporated by reference herein in their entireties.

### BACKGROUND

Embodiments of the present disclosure described herein relate to a zone control unit including a system-on-chip (SoC) which performs radar signal processing.

Technology is provided for connecting a sub-network, which performs a communication based on a controller area network (CAN) protocol as a vehicle network system, to a network switch and configuring a main network, which is based on an Ethernet protocol, between network switches.

Vehicles are becoming increasingly electrified, and with electrification, more electronic control units (ECUs) are being used. When the ECUs are operated in a conventional distributed electrical and electronic architecture, the weight of wire harnesses may increase significantly. As an electrical and electronic architecture of the vehicle, a zonal architecture technology controlling the ECUs on a zone basis is being focused on.

### SUMMARY

Embodiments of the present disclosure provide a zone control unit which performs radar signal processing.

Embodiments of the present disclosure provide a zone control unit capable of improving the usability of a radar signal.

According to an embodiment, a system-on-chip includes a first processor and a second processor that controls the first processor and controls transmission/reception data through a first network link and a second network link, and the first processor processes radar raw data to generate point cloud data, and the first network link receives the radar raw data from a radar sensor based on a first communication method under control of the second processor, and the second network link transmits the point cloud data to an external processor based on a second communication method different from the first communication method under control of the second processor.

According to an embodiment, an operating method of a system-on-chip includes receiving, at a first processor of the system-on-chip, radar raw data from a radar sensor through a first network link based on a first communication method, processing, at a second processor of the system-on-chip, the radar raw data to generate point cloud data, generating, at the first processor, a network frame based on the point cloud data, and transmitting, at the second processor, the network frame to an external processor through a second network link based on a second communication method different from the first communication method.

According to an embodiment, a vehicle includes a plurality of zone control units, a central control unit that communicates with each of the plurality of zone control units, and a plurality of first Ethernet links, each of which connects a corresponding zone control unit of the plurality of zone control units to the central control unit, and each of the plurality of zone control units includes a first processor that processes radar raw data received from a radar sensor to generate point cloud data, and a second processor that controls the first processor.

### BRIEF DESCRIPTION OF THE FIGURES

The above and other objects and features of the present disclosure will become apparent by describing in detail embodiments thereof with reference to the accompanying drawings.

FIG. 1 is a block diagram describing a network configuration of a vehicle according to an embodiment of the present disclosure.

FIG. 2 is a block diagram describing a configuration of a radar sensor according to an embodiment of the present disclosure.

FIG. 3 is a diagram describing an operation of generating radar raw data of a radar sensor according to an embodiment of the present disclosure.

FIG. 4 is a block diagram describing a configuration of a system-on-chip of a zone control unit according to an embodiment of the present disclosure.

FIG. 5 is a diagram describing an operation of generating point cloud data of a system-on-chip according to an embodiment of the present disclosure.

FIG. 6 is a diagram describing an operation of generating an Ethernet frame of a zone control unit according to an embodiment of the present disclosure.

FIG. 7 is a diagram describing an operation of a zone control unit according to an embodiment of the present disclosure, when a network is abnormal.

FIG. 8 is a diagram describing an operation of a zone control unit according to an embodiment of the present disclosure, when a processor is abnormal.

FIG. 9 is a diagram describing an operation of generating an Ethernet frame of a zone control unit according to an embodiment of the present disclosure.

FIG. 10 is a block diagram describing a network configuration of a vehicle according to an embodiment of the present disclosure.

FIG. 11 is a flowchart describing an operation of a zone control unit according to an embodiment of the present disclosure.

### DETAILED DESCRIPTION

Hereinafter, embodiments of the present disclosure will be described clearly and in detail so that a person skilled in the technical field of the present disclosure may easily practice the embodiments of the present disclosure.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

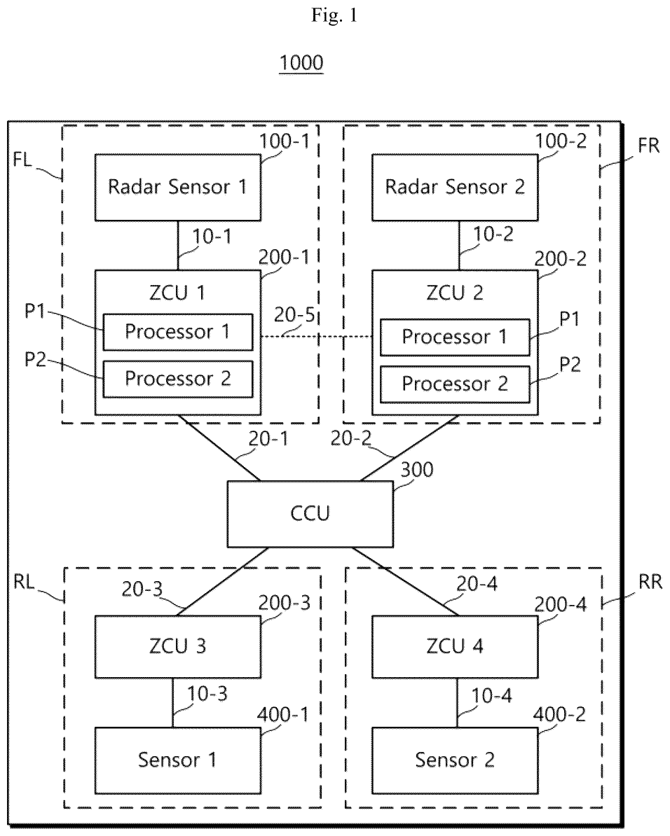

FIG. 1 is a block diagram describing a network configuration of a vehicle 1000 according to an embodiment of the present disclosure.

Referring to FIG. 1, the vehicle 1000 may include a plurality of radar sensors 100-1 and 100-2, a plurality of zone control units 200-1, 200-2, 200-3, and 200-4, a central control unit 300, a plurality of sensors 400-1 and 400-2, and a plurality of network links 10-1, 10-2, 20-1, 20-2, 20-3, and 20-4.

The vehicle 1000 may be operated in a zone architecture. A network system of the vehicle 1000 illustrated in FIG. 1 is a system for performing a communication between a plurality of ECUs mounted on the vehicle 1000. In this case, as illustrated in FIG. 1, the vehicle 1000 may be divided into multiple zones, such that the ECUs are organized based on their locations (zones).

For example, the vehicle 1000 may be divided into four zones. FIG. 1 illustrates, for example, that the vehicle 1000 is divided into four zones. Referring to FIG. 1, it is illustrated that the vehicle 1000 is divided into a first zone FL on a front left, a second zone FR on a front right, a third zone RL on a rear left, and a fourth zone RR on a rear right.

Unlike the division of the vehicle 1000 in FIG. 1, the vehicle 1000 may be divided into a different number of zones based on an operating method. For example, the vehicle 1000 may be divided into seven zones: a front left, a front middle, a front right, a middle left, a middle right, a rear left, and a rear right. Alternatively, the vehicle 1000 may be divided into a larger number of zones or a smaller number of zones.

At least one ECU may be installed in each of the zones (i.e., the first zone FL, the second zone FR, the third zone RL, and the fourth zone RR) of the vehicle 1000. Each ECU may control a corresponding sensor, a corresponding actuator, and the like. For example, each of radar sensor 100-1 and 100-2 located in the first zone FL and the second zone FR respectively may include a respective ECU, and each of sensor 400-1 and 400-2 located in the third zone RL and the fourth zone RR respectively may include a respective ECU. An ECU may refer to an embedded system in automotive electronics that controls one or more electrical systems or subsystems of the automotive vehicle. An ECU may be implemented with one or more processors or controllers, and in some embodiments may be associated with a particular component, such as a sensor, actuator, etc.

Although FIG. 1 illustrates one radar sensor (i.e., the radar sensor 100-1 or the radar sensor 100-2) or one sensor (i.e., the sensor 400-1 or the sensor 400-2) located in each of the zones (i.e., the first zone FL, the second zone FR, the third zone RL, and the fourth zone RR), multiple sensors may be located in each of the zones (i.e., the first zone FL, the second zone FR, the third zone RL, and the fourth zone RR). Alternatively, multiple actuators may be located in each of the zones (i.e., the first zone FL, the second zone FR, the third zone RL, and the fourth zone RR). Alternatively, multiple sensors and multiple actuators may be located in each of the zones (i.e., the first zone FL, the second zone FR, the third zone RL, and the fourth zone RR). In some embodiments, a separate ECU may control each respective sensor or actuator.

Each of the zone control units 200-1 to 200-4 may control the ECUs located in corresponding zones (i.e., the first zone FL, the second zone FR, the third zone RL, and the fourth zone RR). For example, the first zone control unit 200-1 may control the ECUs located in the first zone FL, the second zone control unit 200-2 may control the ECUs located in the second zone FR, the third zone control unit 200-3 may control the ECUs located in the third zone RL, and the fourth zone control unit 200-4 may control the ECUs located in the fourth zone RR. FIG. 1 illustrates, for example, that the first zone control unit 200-1 controls the first radar sensor 100-1, the second zone control unit 200-2 controls the second radar sensor 100-2, the third zone control unit 200-3 controls the first sensor 400-1, and the fourth zone control unit 200-4 controls the second sensor 400-2.

The zone control units 200-1 to 200-4 may have at least one processor, and related circuits. For example, the zone control units 200-1 to 200-4 may include network interface circuits and memory circuits. The zone control units 200-1 to 200-4 may include volatile and nonvolatile storage in read-only memory (ROM), random-access memory (RAM), and keep-alive memory (KAM), for example. They may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions. The zone control units 200-1 to 200-4 may include the network interface circuits for Controller Area Network (CAN), Local Interconnect Network (LIN), FlexRay, and Ethernet. Each zone control unit may be a separate controller.

The zone control units 200-1 to 200-4 may respectively communicate with corresponding ECUs through the first network links 10-1, 10-2, 10-3, and 10-4 and may control the corresponding ECUs. Each of the first network links 10-1 to 10-4 may be based on the same communication method or on different communication methods from each other. For example, some (i.e., the network links 10-1 and 10-2) of the first network links 10-1 to 10-4 and the others (i.e., the network links 10-3 and 10-4) of the first network links 10-1 to 10-4 may transmit data based on different communication methods. The different communication methods may mean communication methods based on different protocols and/or different physical layers.

The zone control units 200-1 and 200-2 may communicate with the first radar sensor 100-1 and the second radar sensor 100-2, respectively.

The first radar sensor 100-1 and the second radar sensor 100-2 may detect information of an object by processing a received radar signal. The received radar signal may be a signal reflected from the object, which is a transmission radar signal emitted by the first radar sensor 100-1 or the second radar sensor 100-2. The information of the object may include at least one of a range, a velocity, and a direction.

In an embodiment, the first radar sensor 100-1 and the second radar sensor 100-2 may be replaced with a light detection and ranging (LiDAR) sensor.

In an embodiment, the first radar sensor 100-1 and the second radar sensor 100-2 may process the received radar signal to detect direction of arrival (DOA) information. The DOA information refers to information indicating a direction in which the received radar signal reflected from the object is received. The first radar sensor 100-1 and the second radar sensor 100-2 may identify the direction in which the object exists based on a position of each of the first radar sensor 100-1 and the second radar sensor 100-2, based on the DOA information. Alternatively, the zone control units 200-1 and 200-2, and the central control unit 300 may identify the direction in which the object exists based on the position of each of the first radar sensor 100-1 and the second radar sensor 100-2, based on the DOA information.

According to an embodiment of the present disclosure, the first radar sensor 100-1 and the second radar sensor 100-2 may process the received radar signal to generate radar raw data. Each of the first radar sensor 100-1 and the second radar sensor 100-2 may transmit the radar raw data to the first zone control unit 200-1 and the second zone control unit 200-2 through the first network links 10-1 and 10-2. For example, the first radar sensor 100-1 may transmit the radar raw data to the first zone control unit 200-1 through the first network link 10-1, and the second radar sensor 100-2 may transmit the radar raw data to the second zone control unit 200-2 through the first network link 10-2. Each radar sensor may include components controlled by an ECU. For example, each radar sensor may have its own processor which controls its components, and the processor of each radar sensor may be controlled by the ECU. The ECU communicates with an associated zone control unit.

In an embodiment, the first network links 10-1 and 10-2 may be based on a mobile industry processor interface (MIPI) camera serial interface (CSI) standard. The first radar sensor 100-1 and the second radar sensor 100-2 may transmit the radar raw data, for example, via a corresponding ECU, to the first zone control unit 200-1 and the second zone control unit 200-2, respectively, based on a transmission protocol of the MIPI CSI. According to an embodiment, a physical layer of the first network links 10-1 and 10-2 may be based on any one of a MIPI D-PHY, a MIPI C-PHY, and a MIPI A-PHY standard.

The first zone control unit 200-1 and the second zone control unit 200-2 may process the radar raw data to generate point cloud data.

Each of the first zone control unit 200-1 and the second zone control unit 200-2 includes a plurality of processors P1 and P2.

The second processor P2 of each of the first zone control unit 200-1 and the second zone control unit 200-2 receives the radar raw data from the radar sensors 100-1 and 100-2 through the first network links 10-1 and 10-2. The first processor P1 may generate the point cloud data by processing the radar raw data under control of the second processor P2. The second processor P2 may transmit the point cloud data to the central control unit 300 through the second network links 20-1 and 20-2.

The first processor P1 may be a signal processing dedicated processor for improving a signal processing performance for generating the point cloud data from the radar raw data. In an embodiment, the first processor P1 may be at least one of a digital signal processing (DSP) processor, a neural processing unit (NPU), a graphics processing unit (GPU), and a general-purpose computing on graphics processing units (GPGPU), and the second processor may be a general-purpose processor.

For example, the first processor P1 may be a processor including an integrated circuit (IC) which processes a signal through a digital operation. The first processor P1 may be the DSP processor including circuits which perform digital signal processing.

For example, the first processor P1 may be a processor which performs a parallel operation based on a neural network. The first processor P1 may be the NPU, the GPU, and the GPGPU including a neural network layer composed of scalar, vector, and tensor mathematics, and circuits which enhance a computational performance of a nonlinear activation function.

The zone control units 200-1 and 200-2 may quickly process the radar raw data as well as simply control ECUs so as to generate the point cloud data by including the first processor P1 separately from the second processor P2 which is the general-purpose processor. Each processor may be formed on a separate semiconductor chip or separate semiconductor package. For example, the second processor P2 may receive the radar raw data from the radar sensor (100-1 or 100-2) and may send the radar raw data to the second processor P1, which processes the data to generate point cloud data and sends the point cloud data back to the second processor P2. The first processor P1 and second processor P2 may communicate with each other through a plurality of inter-chip or inter-package communication terminals.

In an embodiment, the second network links 20-1 and 20-2 may be based on an Ethernet standard. Each of the first zone control unit 200-1 and the second zone control unit 200-2 may transmit the point cloud data to the central control unit 300 based on a transmission protocol of the Ethernet. According to an embodiment, a physical layer of the second network links 20-1 and 20-2 may be based on an automotive Ethernet. For example, the physical layer of the second network links 20-1 and 20-2 may be based on either an institute of electrical and electronics engineers (IEEE) 100BASE-T1 or an IEEE 1000. In addition, the second network links 20-1 and 20-2 may be based on any one of a protocol and/or a physical layer of the automotive Ethernet.

In an embodiment, the first zone control unit 200-1 and the second zone control unit 200-2 may communicate with each other through a second network link 20-5. According to an embodiment, the vehicle 1000 may not include the second network link 20-5 connecting the first zone control unit 200-1 to the second zone control unit 200-2.

The central control unit 300 may be any one of a central gateway (CGW), an advanced driver assistance system (ADAS) controller, and an autonomous driving controller. The central control unit 300 may be a control unit which controls an operation of the vehicle 1000 based on sensor data generated by different types of sensors. The operation of the vehicle 1000 may include an operation associated with driving. The central control unit 300 may have at least one processor, and related circuits. For example, the central control unit 300 may include network interface circuits, memory circuits. The central control unit 300 may include volatile and nonvolatile storage in read-only memory (ROM), random-access memory (RAM), and keep-alive memory (KAM), for example. They may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions. The central control unit 300 may include the network interface circuits for Ethernet.

In the vehicle 1000 according to an embodiment of the present disclosure, each of the first zone control unit 200-1 and the second zone control unit 200-2 receives the radar raw data from each of the first radar sensor 100-1 and the second radar sensor 100-2 and transmits the point cloud data generated by processing the radar raw data to the central control unit 300. Accordingly, the central control unit 300 may use more information than information of a detected object generated based on the point cloud data.

Typically, the object detection information includes only information on a location, a speed, and the like of the detected object, but the point cloud data may include a plurality of point clouds associated with the detected object. In addition, the point cloud data may include point clouds which are not associated with the detected object. The central control unit 300 may acquire additional information of the object and a surrounding environment through processing, such as fusing the point cloud data based on the radar sensors 100-1 and 100-2 with data of other types of sensors (e.g., RGB camera sensors).

The vehicle 1000 may secure a network bandwidth for transmitting the point cloud data by connecting each of the zone control units 200-1 and 200-2 controlling the radar sensors 100-1 and 100-2 to the central control unit 300 through each of the second network links 20-1 and 20-2 based on the automotive Ethernet.

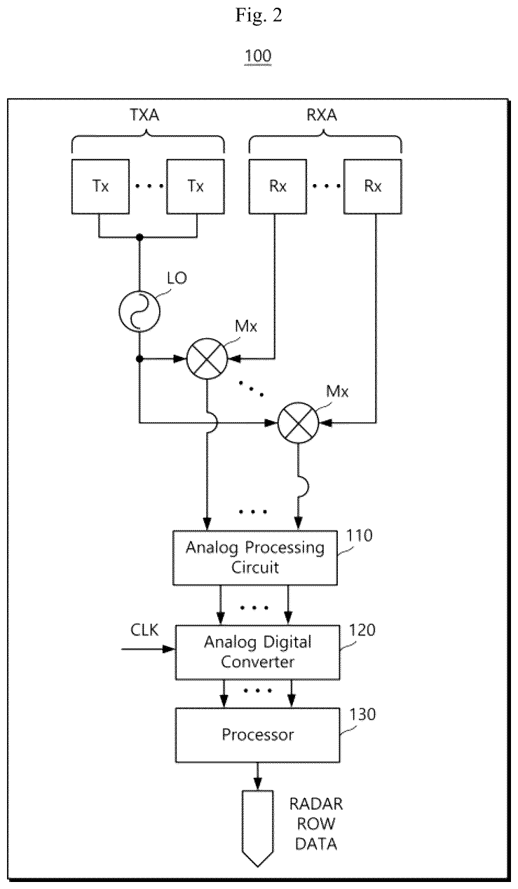

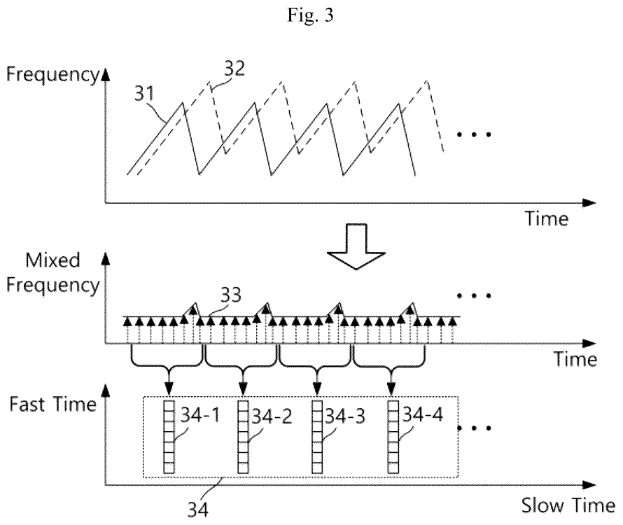

FIG. 2 is a block diagram describing a configuration of a radar sensor 100 according to an embodiment of the present disclosure. FIG. 3 is a diagram describing an operation of generating radar raw data of the radar sensor 100. The radar sensor 100 of FIG. 2 may correspond to each of the radar sensors 100-1 and 100-2 described with reference to FIG. 1. The radar sensor 100 and an operation of the radar sensor 100 are described with reference to FIG. 1, FIG. 2, and FIG. 3. A detailed description of the parts which are similar to or duplicated with the radar sensors 100-1 and 100-2 described with reference to FIG. 1 will be omitted.

The vehicle 1000 of FIG. 1 may include at least one radar sensor 100.

The radar sensor 100 may be based on any one of a pulse method, a frequency modulated continuous wave (FMCW) method, and a frequency shift keying (FSK) method. In the present specification, examples are described on the premise that the radar sensor 100 is a radar sensor based on the FMCW method. However, the radar sensor 100 is not limited to the radar sensor based on the FMCW method.

In an embodiment, the radar sensor 100 may include a plurality of transmission antennas Tx, a plurality of reception antennas Rx, an analog processing circuit 110, an analog digital converter 120, and a processor 130.

The transmission antennas Tx may emit a transmission radar signal 31, and the reception antennas Rx may receive a reception radar signal 32 which is the emitted transmission radar signal reflected from the object.

Each of the transmission antennas Tx may emit the transmission radar signal based on an oscillation signal of a local oscillator LO. The oscillation signal of the local oscillator LO may be converted into an analog input signal, and the converted oscillation signal may be input to each of mixers Mx. The reception radar signal 32 received from each of the reception antennas Rx may be input to different mixers Mx. At least one radio frequency (RF) channel may be formed by a combination of each of the transmission antennas Tx and the reception antennas Rx.

The mixer Mx may obtain a primary analog signal by mixing the oscillation signal of the local oscillator LO and a frequency of the local oscillator LO with the reception radar signal 32 provided by a corresponding reception antenna Rx.

The analog processing circuit 110 may convert each primary analog signal into an analog input signal 33.

The analog digital converter 120 may sample the analog input signal 33 based on a sampling clock signal CLK and may generate a digital radar signal. The digital radar signal may be provided to the processor 130.

The processor 130 may process the digital radar signal to generate digital raw data 34. The digital raw data 34 may be a signal in which a digital radar signal is arranged by chirp. The processor 130 may separate each sample included in the digital radar signal by chirp and generate digital raw data 34-1, 34-2, 34-3, 34-4, . . . based on each chirp. Each of the digital raw data 34-1, 34-2, 34-3, 34-4, . . . may be composed of a slow time index (i.e. for each chirp index) and a fast time index (i.e. for each sample index). Alternatively, the processor 130 may generate digital raw data 34-1, 34-2, 34-3, 34-4, . . . based on each chirp as a matrix-type digital raw data. The processor 130 may transmit the digital raw data 34 to the zone control units 200-1 and 200-2 through the first network links 10-1 and 10-2 of FIG. 1. In an embodiment, the processor 130 may transmit the digital raw data 34 to the zone control units 200-1 and 200-2 in units of digital raw data 34-1, 34-2, 34-3, 34-4, . . . based on each chirp or as the matrix-type digital raw data.

In an embodiment, the radar sensor 100 may generate the digital raw data 34 based on a configuration and a method other than the configuration and the radar signal processing method described with reference to FIG. 2 and FIG. 3. The configuration of the radar sensor 100 and the radar signal processing method are not limited to the embodiments described with reference to FIG. 2 and FIG. 3.

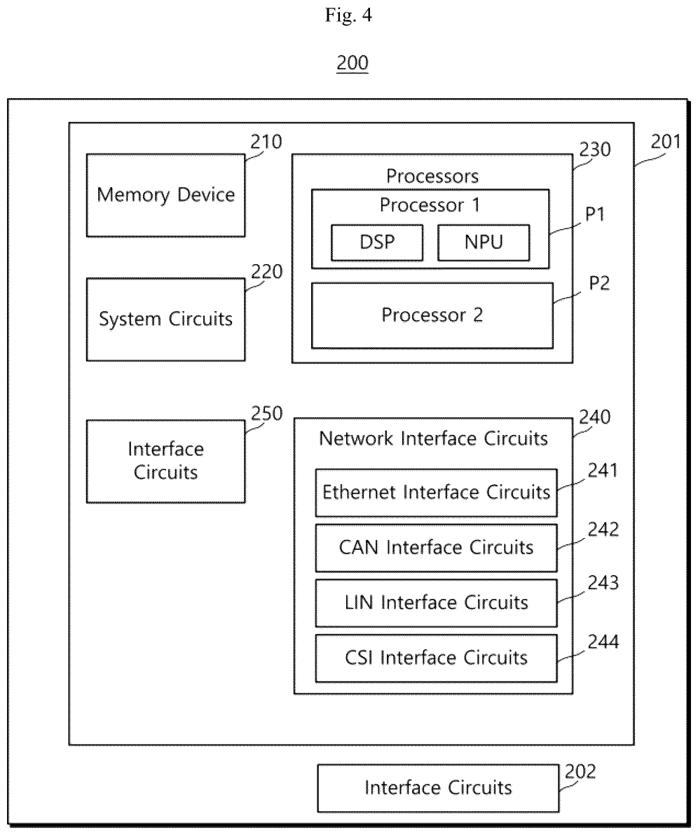

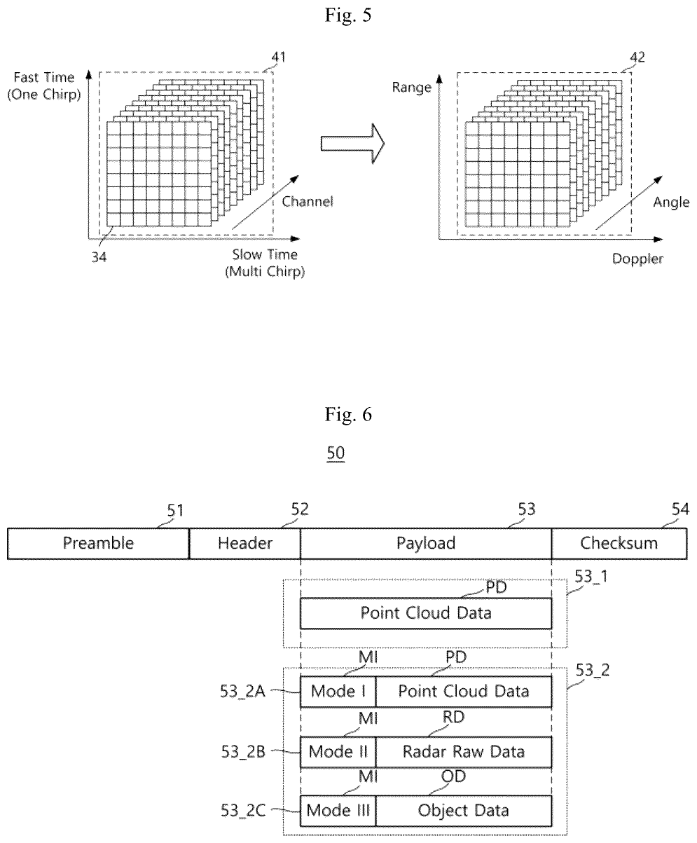

FIG. 4 is a block diagram describing the configuration of a zone control unit 200 according to an embodiment of the present disclosure. FIG. 5 is a diagram describing an operation of generating the point cloud data of the zone control unit 200. The zone control unit 200 of FIG. 4 may correspond to each of the zone control units 200-1 and 200-2 described with reference to FIG. 1. The zone control unit 200 and operations of the zone control unit 200 will be described with reference to FIG. 1, FIG. 4, and FIG. 5. A detailed description of the parts which are similar to or duplicated with the zone control units 200-1 and 200-2 described with reference to FIG. 1 will be omitted.

The zone control unit 200 may include a system-on-chip 201 and interface circuits 202. The zone control unit 200 may be a controller configured to perform various processes as described herein.

The system-on-chip 201 according to an embodiment of the present disclosure may receive the digital raw data 34 of FIG. 3 from the radar sensor 100 of FIG. 2 and may generate point cloud data 42 of FIG. 5 based on the digital raw data 34.

The interface circuits 202 may be circuits which provide a physical connection with an external circuit of the zone control unit 200. For example, the interface circuits 202 may include a connector circuit for connecting wires and/or cables.

In an embodiment, the zone control unit 200 may include other devices in addition to the system-on-chip 201 and the interface circuits 202 illustrated in FIG. 4. For example, the zone control unit 200 may include a memory device such as a dynamic random access memory (DRAM) device or a non-volatile memory (NVM) device.

The system-on-chip 201 may include a memory device 210, system circuits 220, processors 230, and network interface circuits 240.

In an embodiment, the memory device 210 may include a static RAM (SRAM) device. The memory device 210 may function as a buffer. For example, the memory device 210 may temporarily store the digital raw data 34 of FIG. 3. Additionally, the memory device 210 may temporarily store interim data necessary for an operation of generating the point cloud data 42 of FIG. 5 based on the digital raw data 34 of FIG. 3. In addition, the memory device 210 may temporarily store instructions for performing an operation by executing instructions of the processors 230 or may temporarily store data.

In an embodiment, the system circuits 220 may include a test circuit and/or a phase synchronization circuit. For example, the test circuit may include a built-in self-test (BIST) circuit. The phase synchronization circuit may include a phase locked loop (PLL) circuit or a delay-locked loop (DLL) circuit. The system circuits 220 may include other circuits in addition to the test circuit and/or the phase synchronization circuit.

In an embodiment, the processors 230 may include the first processor P1 and the second processor P2. Each of the first processor P1 and the second processor P2 may correspond to each of the first processor P1 and the second processor P2 described with reference to FIG. 1.

The first processor P1 may include at least one of the DSP processor, the NPU, the GPU, and the GPGPU, and the second processor P2 may be the general-purpose processor, such as a microprocessor configured for different types of processing, and not designed for a specific processing function. Although FIG. 4 illustrates that the first processor P1 includes both the DSP processor and the NPU, the first processor P1 may selectively include only one of the DSP processor and the NPU, according to an embodiment.

In an embodiment, the first processor P1 may be the DSP processor.

The first processor P1 may perform a signal processing operation on the digital raw data 34 of FIG. 3 stored in the memory device 210 under control of the second processor P2 and may generate the point cloud data 42 of FIG. 5.

For example, referring to FIG. 5, the first processor P1 may merge the digital raw data 34-1, 34-2, 34-3, 34-4, . . . based on each chirp of FIG. 3 to generate two-dimensional digital raw data 34 for each channel. The first processor P1 may generate three-dimensional digital raw data 41 by merging each of the two-dimensional digital raw data 34 for each channel. The channel may be based on pairing of the transmission antenna and the reception antenna. In an embodiment, a part of the channel may be based on a virtual transmission antenna and/or a virtual reception antenna. The channel may be based on a multiple-input and multiple-output (MIMO) radar sensor.

The first processor P1 may generate the point cloud data 42 by performing fast fourier transform (FFT) processing on the three-dimensional digital raw data 41. The point cloud data 42 may include information on a distance to the object, a Doppler speed, and an angle.

In an embodiment, to obtain accurate information on the angle, the first processor P1 may perform an operation based on an algorithm for estimating a direction of arrival (DOA) such as a multiple signal classification (MUSIC) under control of the second processor P2. For example, the second processor P2 may send commands and raw data to the first processor P1 to control the first processor P1 to perform the signal processing on the raw data. The commands may indicate a type of processing and/or amount of processing to perform. The second processor P2 may send values of some variables for MUSIC to the first processor P1. For example, the second processor P2 may send values of at least one of a number of objects, a number of antennas, an interval between antennas, and an angle range for estimating the DOA. The values transmitted by the second processor are not limited to the variables mentioned above. When the second processor P2 wants to order the first processor P1 to perform other operation except MUSIC, the second processor P2 may indicate a type of other operation and send values of some variables for other operation to the first processor P1.

In an embodiment, the first processor P1 may include the NPU.

The first processor P1 may generate the point cloud data 42 by using a training model based on a neural network. Parameters of the neural network constituting the training model received from an external memory device of the zone control unit 200 may be stored in the memory device 210 of the system-on-chip 201.

For example, a learning model may be a model learned based on learning data in which the three-dimensional digital raw data acquired in different environments are labeled with the point cloud data corresponding to each of the three-dimensional digital raw data. For example, parameters of the neural network included in the learning model may be parameters determined based on the learning data.

In an embodiment, the point cloud data, which is a labeling of the learning data, may be generated by measuring a distance and an angle of an actual object in an environment where each of the three-dimensional digital raw data is obtained. Alternatively, the point cloud data may be calculated by performing an operation based on the FFT processing and/or the DOA algorithm described above on each of the dimensional digital raw data.

In an embodiment, the first processor P1 may perform an operation based on a continuous false alarm rate (CFAR) algorithm under control of the second processor P2 and may remove some points from the point cloud data 42. The first processor P1 may set a threshold according to a level of an average external interference noise, based on the CFAR.

In an embodiment, the first processor P1 may remove some points from the point cloud data 42 based on a fixed threshold value under control of the second processor P2.

In an embodiment, the first processor P1 may filter outliers from the point cloud data from which some points are removed based on the threshold value under control of the second processor P2. For example, the first processor P1 may calculate a distance between points by using location information of the points and/or the Doppler speed of the points and may remove the outliers from the point cloud data based on the calculated distance.

In an embodiment, the first processor P1 may perform an operation of an algorithm for performing outlier filtering under control of the second processor P2. For example, the first processor P1 may perform an operation of a static outlier removal (SOR) filter or an operation based on a radius outlier removal (ROR) filter.

The zone control unit 200 may generate the point cloud data with a reduced data size from the radar raw data by performing operations for generating the point cloud data by itself as described above. Accordingly, the zone control unit 200 may transmit the point cloud data including physically useful information to the central control unit 300 of FIG. 1 through the second network links 20-1 and 20-2 without a load on the network bandwidth.

FIG. 6 is a diagram describing an Ethernet frame 50 according to an embodiment of the present disclosure. The Ethernet frame 50 described with reference to FIG. 6 may be generated in the zone control unit 200 of FIG. 1 and FIG. 4. The Ethernet frame 50 generated by the zone control unit 200 will be described with reference to FIG. 1 and FIG. 6. A detailed description of the parts which are similar to or duplicated with the descriptions of FIG. 1 to FIG. 5 will be omitted.

The zone control unit 200 of FIG. 1 and FIG. 4 may generate the Ethernet frame 50 based on the point cloud data.

The Ethernet frame 50 may include a preamble 51, a header 52, a payload 53, and a checksum 54.

The preamble 51 may include an 8-byte bit pattern indicating a start of transmission of the Ethernet frame.

The header 52 may include media access control (MAC) addresses of each transmitter and each receiver. Each MAC address may have a length of 6 bytes.

The checksum 54 is transmitted at the end of the Ethernet frame 50. The value included in the checksum may be calculated by using a standardized algorithm implemented in the same manner at the transmitter and at the receiver. For example, the zone control unit 200 and the central control unit 300 of FIG. 1 may calculate the checksum based on the same algorithm. The checksum may be calculated based on all fields of the Ethernet frame 50. The integrity of the Ethernet frame 50 may be guaranteed through the checksum.

The Ethernet frame 50 according to an embodiment of the present disclosure may include point cloud data PD in the payload 53. For example, the point cloud data 42 of FIG. 5 may be divided and included as the point cloud data PD of the payload 53 of the at least one Ethernet frame 50.

In an embodiment, the payload 53 may include the point cloud data PD. For example, the zone control unit 200 of FIG. 1 may transmit an Ethernet frame 53_1 including the point cloud data PD to the central control unit 300.

In an embodiment, the payload 53 may include mode information MI.

For example, the zone control unit 200 of FIG. 1 may generate the Ethernet frame 50 based on a payload 53_2A including the mode information MI and the point cloud data PD. The zone control unit 200 may transmit the generated Ethernet frame 50 to the central control unit 300 of FIG. 1. The mode information MI may be information indicating that the point cloud data PD is included in the payload.

For example, the zone control unit 200 of FIG. 1 may generate the Ethernet frame 50 based on a payload 53_2B including the mode information MI and radar raw data RD. The zone control unit 200 may transmit the generated Ethernet frame 50 to the central control unit 300 of FIG. 1 or a zone control unit of another zone. For example, the first zone control unit 200-1 of FIG. 1 may transmit the Ethernet frame 50 based on the payload 53_2B including the mode information MI and the radar raw data RD to the second zone control unit 200-2 through the second network link 20-5. Alternatively, the first zone control unit 200-1 of FIG. 1 may transmit the Ethernet frame 50 based on the payload 53_2B including the mode information MI and the radar raw data RD to the central control unit 300 through the second network link 20-1.

For example, the zone control unit 200 of FIG. 1 may generate the Ethernet frame 50 based on a payload 53_2C including the mode information MI and information of detected object OD. The zone control unit 200 may transmit the generated Ethernet frame 50 to the central control unit 300 of FIG. 1 or to a zone control unit of another zone. For example, the first zone control unit 200-1 of FIG. 1 may transmit the Ethernet frame 50 based on the payload 53_2C including the mode information MI and the information of detected object OD to the second zone control unit 200-2 through the second network link 20-5. Alternatively, the first zone control unit 200-1 of FIG. 1 may transmit the Ethernet frame 50 based on the payload 53_2C including the mode information MI and the information of detected object OD to the central control unit 300 through the second network link 20-1.

In this case, the zone control unit 200 may perform an operation for object detection on the point cloud data and may detect the object. For example, the points of the point cloud data may be clustered, and when the points of the cluster are greater than or equal to a preset value, it may be determined that the object exists at a location of the corresponding cluster. The zone control unit 200 may generate the payload 53_2C based on the information of detected object OD with the distance, the Doppler speed, and/or the angle of the points corresponding to the detected object.

In an embodiment, the vehicle 1000 of FIG. 1 may use the point cloud data based on an operation policy, an environment, and/or a situation, or may use the information of the detected object without using the point cloud data (e.g., may use the information of the detected object without further use of the point cloud data). For example, the first processor P1 may perform an object detection operation which is generally known to detect objects from the radar raw data. Alternatively, the vehicle 1000 may request the radar raw data from the zone control unit 200. The central control unit 300 of FIG. 1 may transmit a control message requesting the point cloud data to the zone control unit 200 of FIG. 1 and FIG. 4 as needed, or a control message requesting the information of the detected object to the zone control unit 200. The zone control unit 200 may insert the mode information MI into the payload 53_2 of the Ethernet frame 50 in response to the control message received from the central control unit 300.

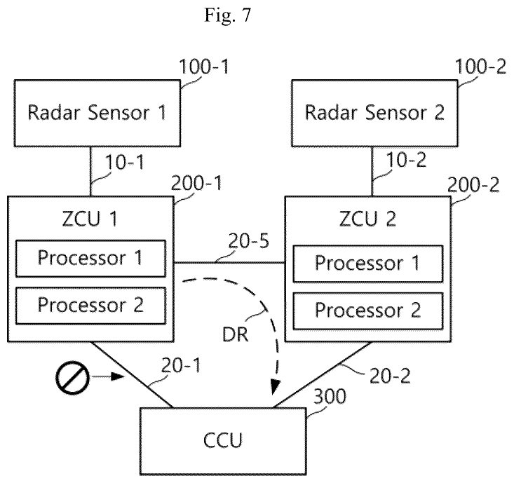

FIG. 7 is a diagram describing an operation of a zone control unit according to an embodiment of the present disclosure, when a network is abnormal. An operation of FIG. 7 may be performed in the zone control unit 200 of FIG. 1 and FIG. 4.

In an embodiment, the first zone control unit 200-1 may identify a failure of the second network link 20-1 connected to the central control unit 300. In this case, the first zone control unit 200-1 may transmit the Ethernet frame including the point cloud data to the second zone control unit 200-2 through the second network link 20-5. The first zone control unit 200-1 may transmit the Ethernet frame including the mode information MI described above with reference to FIG. 6 to the second zone control unit 200-2. The mode information MI may indicate that the point cloud data is included in the payload.

In an embodiment, when the first zone control unit 200-1 identifies a failure of the second network link 20-1 connected to the central control unit 300, the first zone control unit 200-1 may transmit the Ethernet frame including the information of the detected object to the second zone control unit 200-2 through the second network link 20-5. The first zone control unit 200-1 may transmit the Ethernet frame including the mode information MI described above with reference to FIG. 6 to the second zone control unit 200-2. The mode information MI may indicate that the information of the detected object is included in the payload. In this case, by transmitting the Ethernet frame including the information of the detected object to the second zone control unit 200-2, the second zone control unit 200-2 may reduce a load of an operation for generating the point cloud data based on the radar raw data of the first radar sensor 100-1.

The second zone control unit 200-2 may transmit the Ethernet frame generated based on the Ethernet frame received from the first zone control unit 200-1 to the central control unit 300 through the second network link 20-2. Accordingly, the point cloud data based on the radar raw data of the first radar sensor 100-1 may be safely transmitted to the central control unit 300 through a detour path DR.

In an embodiment, the second zone control unit 200-2 may process the payload based on the mode information MI of the Ethernet frame received from the first zone control unit 200-1.

For example, when the mode information MI indicates that any one of the point cloud data and the information of the detected object is included in the payload, the second zone control unit 200-2 may generate the Ethernet frame including identification information. The identification information may be information for distinguishing the Ethernet frame based on the radar raw data of the second radar sensor 100-2 and the Ethernet frame based on the radar raw data of the first radar sensor 100-1 (i.e., based on the Ethernet frame transmitted by the first zone control unit 200-1). Accordingly, the central control unit 300 may determine, based on the identification information, which radar sensor the point cloud data or the information of the detected object included in the payload of the Ethernet frame transmitted by the second zone control unit 200-2 is based on.

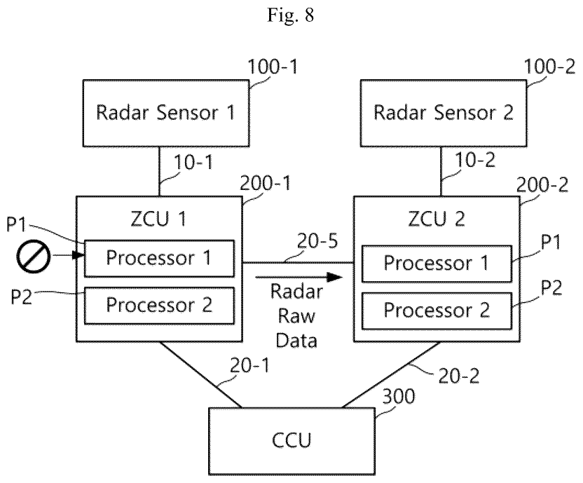

FIG. 8 is a diagram describing an operation of a zone control unit according to an embodiment of the present disclosure, when a processor of the zone control unit is abnormal. The operation of FIG. 8 may be performed by the zone control unit 200 of FIG. 1 and FIG. 4. The zone control unit or another component being “abnormal” refers to the unit or component being in an abnormal state, which may occur when a normal working (e.g., expected) operation of the unit or component is not occurring.

In an embodiment, the second processor P2 of the first zone control unit 200-1 may identify a failure of the first processor P1. In this case, the second processor P2 of the first zone control unit 200-1 may transmit the Ethernet frame including the radar raw data received from the first radar sensor 100-1 to the second zone control unit 200-2 through the second network link 20-5. The first zone control unit 200-1 may transmit the Ethernet frame including the mode information MI described above with reference to FIG. 6 to the second zone control unit 200-2. The mode information MI may indicate that the radar raw data is included in the payload.

In an embodiment, the second zone control unit 200-2 may process the payload based on the mode information MI of the Ethernet frame transmitted from the first zone control unit 200-1. For example, when the mode information MI indicates that the payload includes the radar raw data, the second zone control unit 200-2 may generate the point cloud data by processing the radar raw data of the Ethernet frame transmitted by the first zone control unit 200-1.

In an embodiment, the second zone control unit 200-2 may generate the Ethernet frame including the identification information. The identification information may be information for distinguishing the Ethernet frame based on the radar raw data of the second radar sensor 100-2 and the Ethernet frame based on the radar raw data of the first radar sensor 100-1 (i.e., based on the Ethernet frame transmitted by the first zone control unit 200-1). Accordingly, the central control unit 300 may determine which radar sensor the point cloud data or the information of the detected object included in the payload of the Ethernet frame transmitted by the second zone control unit 200-2 is based on. Accordingly, despite the failure of the first processor P1 of the first zone control unit 200-1, the central control unit 300 may safely receive the point cloud data based on the radar raw data of the first radar sensor 100-1.

In an embodiment, when the second zone control unit 200-2 receives the Ethernet frame from the first zone control unit 200-1, the second zone control unit 200-2 may perform the object detection based on the point cloud data. For example, the second zone control unit 200-2 may generate the point cloud based on the radar raw data of the Ethernet frame from the first zone control unit 200-1 and may detect an object based on the generated point cloud. In addition, the second zone control unit 200-2 may detect an object based on the point cloud data generated by itself.

For example, the second zone control unit 200-2 may generate the Ethernet frame including information of objects detected based on the radar raw data of the Ethernet frame from the first zone control unit 200-1 and the Ethernet frame including objects detected based on the point cloud generated by itself, and may transmit the generated Ethernet frames to the central control unit 300.

Alternatively, the second zone control unit 200-2 may integrate duplicated information of the objects detected based on radar raw data of the Ethernet frame from the first zone control unit 200-1 and the objects detected based on the point cloud generated by itself, may generate a single Ethernet frame including the information of the detected object, and may transmit the generated Ethernet frame to the central control unit 300.

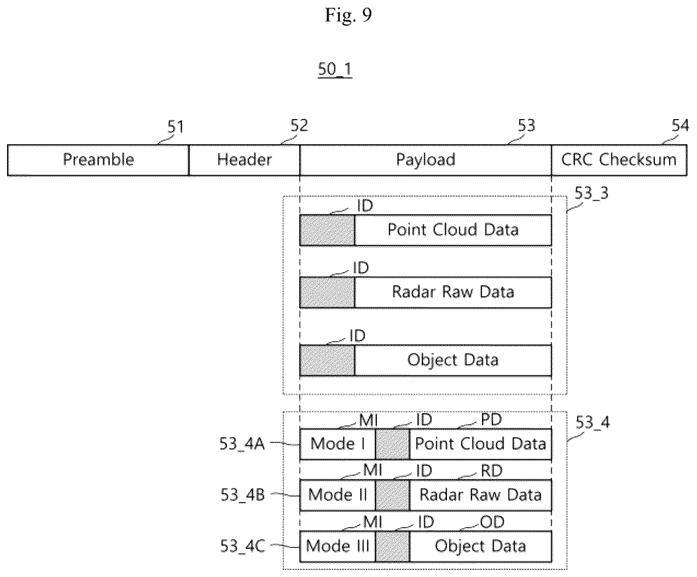

FIG. 9 is a diagram describing an operation of generating an Ethernet frame of a zone control unit according to an embodiment of the present disclosure. An Ethernet frame 50_1 described with reference to FIG. 9 may be generated in the zone control unit 200 of FIG. 1 and FIG. 4. The Ethernet frame 50_1 generated by the zone control unit 200 will be described with reference to FIG. 1 and FIG. 9. A detailed description of the parts which are similar to or duplicated with the descriptions of FIG. 1 to FIG. 8 will be omitted.

The zone control unit 200 may generate the Ethernet frame 50_1 including identification information ID.

In an embodiment, the identification information ID may be generated based on the radar sensor. For example, although FIG. 1 illustrates that the first zone control unit 200-1 controls the first radar sensor 100-1, the first zone control unit 200-1 may additionally control radar sensors other than the first radar sensor 100-1. In this case, the first zone control unit 200-1 may generate the Ethernet frame 50_1 based on a payload 53_3 including the identification information ID indicating which radar sensor the radar raw data is based on for generating the point cloud.

In an embodiment, the identification information ID may be generated based on the zone control unit. For example, as described with reference to FIG. 7 and FIG. 8, the second network link 20-1 of FIG. 7 and/or the first processor P1 of the first zone control unit 200-1 of FIG. 8 may fail. In this case, the first zone control unit 200-1 may include the identification information ID in the payload together with any one of the radar raw data, the point cloud data, and the information of the detected object, as the case may be. In the same manner, the second zone control unit 200-2 may transmit the Ethernet frame 50_1 including the identification information ID to the central control unit 300 of FIG. 1, FIG. 7 and FIG. 8. The central control unit 300 may identify which zone control unit the Ethernet frame is based on, based on the identification information ID of the payload 53_3.

In an embodiment, a payload 53_4 of the Ethernet frame 50_1 may include the identification information ID and the mode information MI. The mode information MI may be information indicating which one of the point cloud data PD, the radar raw data RD, and the information of detected object OD is included in the payload 53_4. The identification information ID may be based on the radar sensor or the zone control unit. The central control unit 300 of FIG. 1, FIG. 7, and FIG. 8 may process a payload based on the identification information ID and the mode information MI.

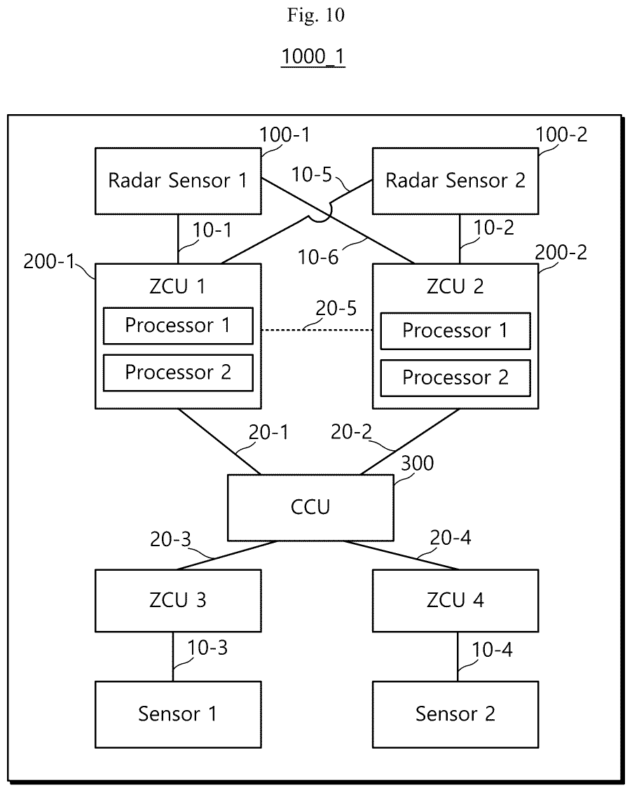

FIG. 10 is a block diagram describing a network configuration of a vehicle 1000_1 according to an embodiment of the present disclosure. The network configuration of the vehicle 1000_1 will be described with reference to FIG. 10. A detailed description of the parts which are similar to or duplicated with the vehicle 1000 described with reference to FIG. 1 will be omitted.

Unlike the vehicle 1000 of FIG. 1, the vehicle 1000_1 of FIG. 10 further includes third network links 10-5 and 10-6 connecting each of the radar sensors 100-1 and 100-2 to each of the plurality of zone control units 200-1 and 200-2.

For example, the first radar sensor 100-1 may be connected to the first zone control unit 200-1 through the network link 10-1 and may be connected to the second zone control unit 200-2 through the third network link 10-6. The second radar sensor 100-2 may be connected to the second zone control unit 200-2 through the network link 10-2 and may be connected to the first zone control unit 200-1 through the third network link 10-5. The network links 10-1, 10-2, 10-5, and 10-6 may be based on the MIPI CSI.

In an embodiment, the first radar sensor 100-1 may transmit the radar raw data to the first zone control unit 200-1 through the network link 10-1. The first radar sensor 100-1 may transmit the radar raw data to the second zone control unit 200-2 through the third network link 10-6 when the first zone control unit 200-1 is abnormal. Similarly, the second radar sensor 100-2 may transmit the radar raw data to the second zone control unit 200-2 through the network link 10-2. The second radar sensor 100-2 may transmit the radar raw data to the first zone control unit 200-1 through the third network link 10-5 when the second zone control unit 200-2 is abnormal. An abnormal detection may be made, for example, by one of the first radar sensor 100-1 or the second radar sensor 100-2 or the first zone control unit 200-1 or the second zone control unit 200-2 or by the central control unit 300, based on one or more monitoring processes, for example, which detect processing, communication, or power abnormalities not within the typical operating parameters for the system. For example, if the first radar sensor 100-1 can't receive an acknowledge message from the first zone control unit 200-1 in response to a message, the first radar sensor 100-1 may determine that the first zone control unit 200-1 is abnormal. Similarly, the central control unit 300 may determine that the first zone control unit 200-1 or the second zone control unit 200-2 is abnormal if the central control unit 300 can't receive a response message from one of them. For other examples, each of the first zone control unit 200-1 and the second zone control unit 200-2 has a self test logic circuit, such as Built-In Self Test (BIST) logic circuit. Each of the first zone control unit 200-1 and the second zone control unit 200-2 may perform a self test, and if either of the first zone control unit 200-1 and the second zone control unit 200-2 determines that a fault has occurred, it can transmit a fault message to the first radar sensor 100-1 or the second radar sensor 100-2.

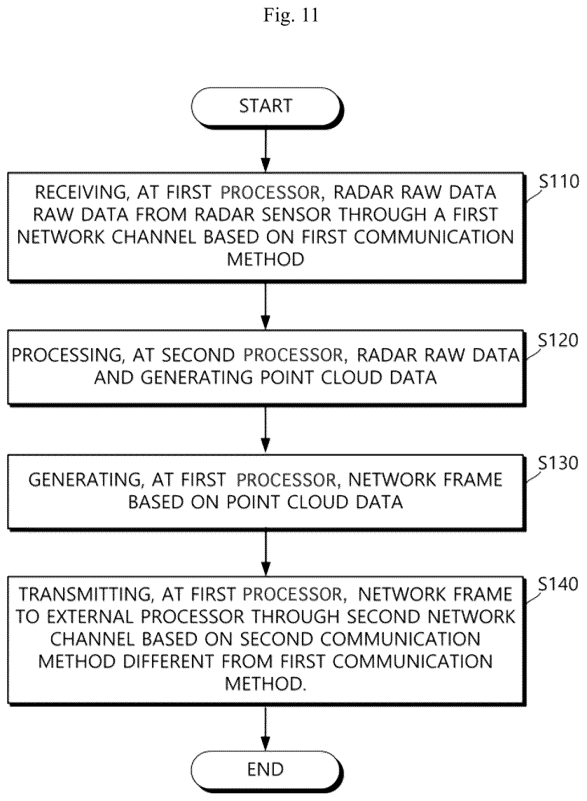

FIG. 11 is a flowchart describing an operation of a zone control unit according to an embodiment of the present disclosure. The operation of the zone control unit will be described with reference to FIG. 11. A detailed description of the parts which are similar to or duplicated with the descriptions of FIG. 1 to FIG. 10 will be omitted.

In operation S110, a first processor of the zone control unit may receive the radar raw data from the radar sensor through the first network link based on a first communication method. The first processor may be the general-purpose processor. The first network link may be based on the MIPI CSI.

In operation S120, a second processor of the zone control unit may generate the point cloud data by processing the radar raw data. The second processor may be any one of the DSP processor, the NPU, the GPU, and the GPGPU. The first processor and the second processor may be implemented in a system-on-chip. The second processor may generate the point cloud data by the method described with reference to FIG. 5.

In operation S130, the first processor may generate a network frame based on the point cloud data. The network frame may be the Ethernet frame. According to an embodiment, the first processor may further include the identification information to generate the Ethernet frame. The identification information may be similar to the identification information of FIG. 9.

In operation S140, the first processor may transmit the network frame to an external processor (e.g., a processor of central control unit 300) through the second network link based on a second communication method different from the first communication method. In an embodiment, the external processor may be any one of the central gateway, the ADAS controller, and the autonomous driving controller. The external processor may be a control unit controlling a vehicle operation based on sensor data generated by different types of sensors. In an embodiment, the external processor may be a zone control unit located in a different zone. For example, as described with reference to FIG. 7 and FIG. 8, one zone control unit may transmit the Ethernet frame to another zone control unit.

According to an embodiment of the present disclosure, the operation of FIG. 11 may be performed in the zone control unit 200 of FIG. 1. For example, the first processor of FIG. 11 may correspond to the second processor of the zone control unit 200 of FIG. 1. The second processor of FIG. 11 may correspond to the first processor of the zone control unit 200 of FIG. 1.

The zone control unit according to the present disclosure may perform radar signal processing.

The zone control unit according to the present disclosure may stably perform the radar signal processing on a zone architecture.

The zone control unit according to the present disclosure may improve the usability of radar signals in the zone architecture.

The above-described contents are specific embodiments for carrying out the present disclosure. In addition to the above-described embodiments, the present disclosure will also include embodiments that may be simply designed or easily changed. In addition, the present disclosure will also include technologies that may be easily modified and implemented by using the embodiments. Therefore, the scope of the present disclosure should not be limited to the above-described embodiments but should be determined by the claims described below as well as the equivalents of the claims of this disclosure.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A system-on-chip comprising:
a first processor; and
a second processor configured to control the first processor and to control transmission and reception of data through a first network link and a second network link,
wherein the first processor is configured to process radar raw data to generate point cloud data,
wherein the first network link is configured to receive the radar raw data from a radar sensor based on a first communication method under control of the second processor, and
wherein the second network link is configured to transmit the point cloud data to an external processor based on a second communication method different from the first communication method under control of the second processor.

2. The system-on-chip of claim 1, wherein the first processor is at least one of a digital signal processing (DSP) processor, a neural processing unit (NPU), a graphics processing unit (GPU), and a general-purpose GPU (GPGPU), and
wherein the second processor is a general-purpose processor.

3. The system-on-chip of claim 1, wherein the first communication method is based on a mobile industry processor interface (MIPI) camera serial interface (CSI) standard, and
wherein the second communication method is based on an Ethernet standard.

4. The system-on-chip of claim 1, wherein the first processor is configured to generate the point cloud data including a point cloud and a Doppler value for each point of the point cloud, and
wherein the second processor is configured to:
generate an Ethernet frame based on the point cloud data including the point cloud and the Doppler value for each point of the point cloud; and
transmit the Ethernet frame to the external processor through the second network link.

5. The system-on-chip of claim 1, wherein the second processor is configured to:
detect an object based on the point cloud data, based on a control message received from the external processor; and
transmit information of the detected object to the external processor through the second network link.

6. The system-on-chip of claim 1, wherein the second processor is configured to transmit the radar raw data to the external processor through the second network link, based on a control message received from the external processor.

7. The system-on-chip of claim 1, wherein the second processor is configured to transmit information of an object detected based on the radar raw data to the external processor through the second network link, based on a control message received from the external processor.

8. The system-on-chip of claim 1, wherein the first processor and the second processor are located in a first zone, and the second processor is configured to, when the first processor is in an abnormal state:
generate an Ethernet frame based on the radar raw data; and
transmit the Ethernet frame to a processor of a zone control unit located in a second zone different from the first zone through the second network link.

9. The system-on-chip of claim 1, wherein the first processor and the second processor are located in a first zone, and the second processor is configured to generate a first Ethernet frame based on the radar raw data,
wherein the second processor is configured to generate a second Ethernet frame based on radar raw data received from a processor of a zone control unit located in a second zone different from the first zone, and
wherein the second processor is configured to insert identification information for distinguishing the first Ethernet frame from the second Ethernet frame to generate the first Ethernet frame and the second Ethernet frame.

10. The system-on-chip of claim 9, wherein the second processor is configured to generate the identification information based on the radar sensor.

11. The system-on-chip of claim 1, wherein the first processor and the second processor are located in a first zone, and the second processor is configured to, when the second network link is in an abnormal state, transmit at least one of the point cloud data and information of an object detected based on the point cloud data to a zone control unit in a second zone different from the first zone through a third network link.

12. A vehicle comprising:
a plurality of zone control units;
a central control unit configured to communicate with each of the plurality of zone control units; and
a plurality of first Ethernet links, each configured to connect a corresponding zone control unit of the plurality of zone control units to the central control unit,
wherein each of the plurality of zone control units includes:
a first processor configured to process radar raw data received from a radar sensor to generate point cloud data; and
a second processor configured to control the first processor.

13. The vehicle of claim 12, further comprising:
at least one second Ethernet link configured to connect the plurality of zone control units to each other,
wherein the plurality of zone control units include a first zone control unit and a second zone control unit,
wherein the first zone control unit is configured to receive first radar raw data from a first radar sensor,
wherein the second zone control unit is configured to receive second radar raw data from a second radar sensor, and
wherein the first zone control unit is configured to transmit the first radar raw data to the second zone control unit through the second Ethernet link when the first processor is in an abnormal state.

14. The vehicle of claim 13, wherein the second zone control unit is configured to generate first point cloud data and second point cloud data based on the first radar raw data and the second radar raw data, respectively.

15. The vehicle of claim 14, wherein the second zone control unit is configured to:
detect an object based on each of the first point cloud data and the second point cloud data; and
transmit information of the detected object to the central control unit through the second Ethernet link.

16. The vehicle of claim 13, further comprising:
first network links configured to connect each of the first radar sensor and the second radar sensor to the first zone control unit; and
second network links configured to connect each of the first radar sensor and the second radar sensor to the second zone control unit,
wherein the first zone control unit is configured to, when the second zone control unit is in an abnormal state,
receive the second radar raw data from the second radar sensor through one of the first network links; and
generate first point cloud data and second point cloud data based on the first radar raw data and the second radar raw data, respectively.

17. An operating method of a system-on-chip, the method comprising:
receiving, at a first processor of the system-on-chip, radar raw data from a radar sensor through a first network link based on a first communication method;
processing, at a second processor of the system-on-chip, the radar raw data to generate point cloud data;
generating, at the first processor, a network frame based on the point cloud data; and
transmitting, at the second processor, the network frame to an external processor through a second network link based on a second communication method different from the first communication method.

18. The method of claim 17, further comprising:
transmitting, at the second processor, the radar raw data to the external processor through the second network link based on a control message received from the external processor.

19. The method of claim 17, wherein the first processor and second processor are located in a first zone, and further comprising:
generating, at the second processor, an Ethernet frame based on the radar raw data when the first processor is in an abnormal state, and transmitting the Ethernet frame to a processor of a zone control unit located in a second zone different from the first zone through the second network link.

20. The method of claim 17, wherein the first processor and second processor are located in a first zone, and further comprising:
generating, at the second processor, a first Ethernet frame based on the radar raw data;
generating, at the second processor, a second Ethernet frame based on radar raw data received from a processor of a zone control unit located in a second zone different from the first zone; and
generating, at the second processor, the first Ethernet frame and the second Ethernet frame by inserting identification information distinguishing the first Ethernet frame and the second Ethernet frame.
